(19) United States
(12) Patent Application Publication
(10) Pub. No.: US 2025/0238565 A1
(43) Pub. Date: Jul. 24, 2025

(54) TECHNIQUES FOR GENERATING ARCHITECTURAL SITE DESIGNS BASED ON CARBON CONSIDERATIONS AND GOALS

(71) Applicant: AUTODESK, INC., San Francisco, CA (US)

(72) Inventors: John Henry LOCKE, New York, NY (US); Matthew Vincent SPREMULLI, Toronto (CA); Damon LAU, New York, NY (US)

(21) Appl. No.: 19/032,975

(22) Filed: Jan. 21, 2025

Related U.S. Application Data
(60) Provisional application No. 63/623,552, filed on Jan. 22, 2024.

(51) Int. Cl. G06F 30/13; G06F 30/12; G06F 30/27; G06F 111/20; G06Q 30/0283; G06Q 50/08

(52) U.S. Cl. CPC G06F 30/13; G06F 30/12; G06F 30/27; G06Q 30/0283; G06Q 50/08; G06F 2111/20

(57) ABSTRACT

One embodiment sets forth a technique for generating architectural site designs based on carbon considerations. According to some embodiments, the technique can include the steps of generating at least one adaptable area for an architectural site design, receiving a plurality of configuration parameters for the at least one adaptable area, generating, via at least one generative artificial intelligence (AI) model, a plurality of design outputs based on the at least one adaptable area and the plurality of configuration parameters, updating the at least one adaptable area based on the plurality of design outputs to generate an updated architectural site design, generating a plurality of carbon metrics based on the updated architectural site design, and displaying, via a user interface, at least a portion of the updated architectural site design and at least a portion of the plurality of carbon metrics.

### CROSS-REFERENCE TO RELATED APPLICATIONS

The present application claims the benefit of U.S. Provisional Application titled, “GENERATIVE DESIGN FOR ARCHITECTURE SITE AND LANDSCAPE DESIGN TO BALANCE CARBON EMISSIONS AND CARBON STORAGE AND SEQUESTRATION,” filed on Jan. 22, 2024, and having Ser. No. 63/623,552. The subject matter of this related application is hereby incorporated herein by reference.

### BACKGROUND

### Field of the Various Embodiments

Embodiments of the present disclosure relate generally to computer science, artificial intelligence, complex software applications, and, more specifically, to techniques for generating architectural site designs based on carbon considerations and goals.

### Description of the Related Art

Architectural site and landscape design considerations can significantly influence the environmental impact of developed environments. With increasing global concerns about climate change, there is a growing interest in reducing carbon emissions—as well as enhancing carbon storage and sequestration—through thoughtful design practices. In this regard, it is important for designers to create spaces that contribute positively to the environment while maintaining functionality for human use.

Currently, architects, landscape designers, etc., often lack immediate feedback on the carbon implications of their design decisions during early conceptual stages. In particular, conventional tools that calculate carbon emissions and sequestration are typically separate and disconnected from standard design software. This separation requires manual data transfer and complex workflows to be performed, which makes it challenging for individuals to efficiently and comprehensively evaluate multiple design iterations. As a result, environmental considerations may not be fully integrated into the design process, which can negatively impact the final design of buildings, their surrounding landscapes, and so on.

One drawback of conventional approaches is that carbon emissions for landscape designs are required to be calculated manually. This manual process often involves using third-party software that has limited integration with industry-standard 3D design tools. The disjointed workflow restricts the number of design options that can be reasonably assessed for carbon impact, thereby limiting the potential for optimizing designs for environmental benefits and goals.

Another drawback of conventional approaches is that detailed information that is needed to accurately perform carbon impact assessments—such as the types and placements of plantings, soil compositions, and material quantities—is typically only available in the later stages of design processes. This delay prevents designers from making informed decisions about carbon balancing when the design is most adaptable. Consequently, opportunities to enhance carbon storage, reduce emissions, and the like, may be missed during the early phases of development.

As the foregoing illustrates, what is needed in the art are more effective techniques for integrating carbon considerations into architectural site designs.

### SUMMARY

One embodiment sets forth a method for generating architectural site designs based on carbon considerations. According to some embodiments, the method includes the steps of generating at least one adaptable area for an architectural site design, receiving a plurality of configuration parameters for the at least one adaptable area, generating, via at least one generative artificial intelligence (AI) model, a plurality of design outputs based on the at least one adaptable area and the plurality of configuration parameters, updating the at least one adaptable area based on the plurality of design outputs to generate an updated architectural site design, generating a plurality of carbon metrics based on the updated architectural site design, and displaying, via a user interface, at least a portion of the updated architectural site design and at least a portion of the plurality of carbon metrics.

One technical advantage of the disclosed techniques relative to the prior art is that the disclosed techniques automate the detection of areas within an architectural site development where elements such as trees, plants, structures, etc., can be installed. This automation can reduce the need for manual identification of such areas, which can help reduce errors and ensure that the areas are identified consistently based on predefined criteria and constraints. Another technical advantage is that the disclosed techniques allow for dynamic adjustments to design parameters through configurable properties. The adjustments can be processed in real-time such that modifications to the design criteria can be reflected with virtually no latency, which can improve the overall precision and relevance of the suggested architectural site designs. A further technical advantage is that the disclosed techniques can programmatically calculate carbon emissions and savings, thereby eliminating the need for manual computations. These calculations can be directly tied to the detected areas and configured parameters, which can help reduce the potential for computational errors. An additional technical advantage is that the disclosed techniques can automatically generate values for the configurable properties based on specified carbon goals. These technical advantages provide one or more technological advancements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 illustrates a network infrastructure configured to implement one or more aspects of various embodiments.

FIG. 2 is a more detailed illustration of the architectural site design of FIG. 1, according to various embodiments.

FIGS. 3A-3E illustrate conceptual diagrams of user interfaces associated with a software application executing on one of the endpoint devices of FIG. 1, according to various embodiments.

FIG. 4A sets forth a flow diagram of method steps for generating architectural site designs based on carbon considerations, according to various embodiments.

FIG. 4B sets forth a flow diagram of method steps for generating architectural site designs based on carbon goals, according to various embodiments.

FIG. 5 is a more detailed illustration of a computing device that can implement the functionalities of the entities illustrated in FIG. 1, according to various embodiments.

### DETAILED DESCRIPTION

In the following description, numerous specific details are set forth to provide a more thorough understanding of the various embodiments. However, it will be apparent to one skilled in the art that the inventive concepts may be practiced without one or more of these specific details.

### System Overview

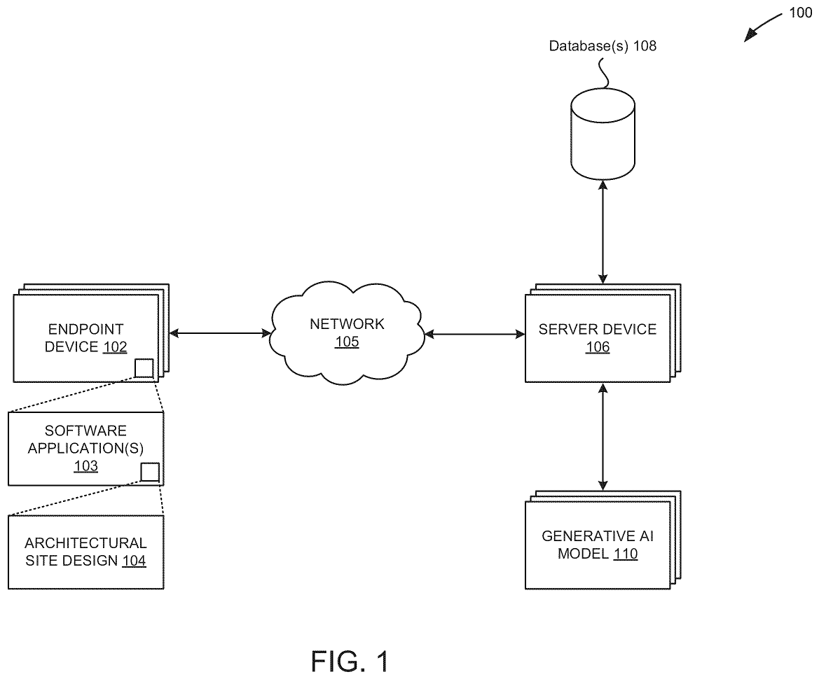

FIG. 1 is a conceptual illustration of a system 100 configured to implement one or more aspects of the various embodiments. As shown, the system 100 includes at least one endpoint device 102, at least one server device 106, at least one database 108, and at least one generative AI model 110, which can communicate between one another via a communications network 105. The communications network 105 can represent, for example, any technically feasible network or number of networks, including a wide area network (WAN) such as the Internet, a local area network (LAN), a Wi-Fi network, a cellular network, or a combination thereof.

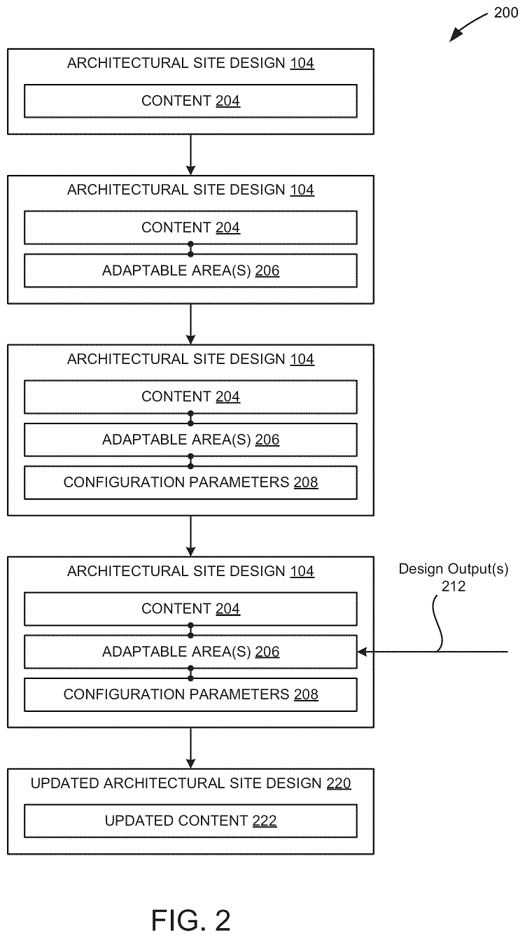

According to some embodiments, an endpoint device 102 can represent a computing device (e.g., a desktop computing device, a laptop computing device, a mobile computing device, etc.). As shown in FIG. 1, at least one software application 103 can be installed on and execute on the endpoint device 102. The software application 103 can represent, for example, a web browser application, a web browser application extension, a productivity application, etc., that enables an architectural site design 104 to be created, imported, etc., as well as modified, interacted with, etc., in accordance with the techniques described herein. For example, as shown in the conceptual diagram 200 illustrated in FIG. 2, an architectural site design 104 can include content 204 that includes all information that defines the architectural site design 104 and that can be interpreted by the software application 103. In one example, the architectural site design 104 can represent a computer-aided design (CAD) file.

According to some embodiments, the software application 103 can be configured to facilitate data collections, user interactions, result presentations, etc., to enable the server device 106 to implement the various techniques described herein. In particular, the software application 103 can collect and transmit input data required by the server device 106 to identify, generate, etc., adaptable areas 206 within an architectural site design 104. For example, the software application 103 can be configured to transmit architectural site-specific information (i.e., real-world information about where the architectural site will be constructed), design constraints, user-provided parameters, etc., that define the scope and characteristics of the adaptable areas 206, or that enable the scope and characteristics of such adaptable areas 206 to be defined, identified, etc., by way of analyses performed by the server device 106.

According to some embodiments, the software application 103 can provide user interfaces through which users can specify and modify configuration parameters 208 for the adaptable areas 206. The configuration parameters 208 can include, for example, zoning parameters, functional area parameters, soil type parameters, ground surface parameters, accessibility parameters, sunlight exposure parameters, wind pattern parameters, tree type parameters, vegetation type parameters, planting density parameters, planting arrangement parameters, irrigation parameters, watering schedule parameters, water feature parameters, drainage parameters, berm parameters, mound parameters, slope parameters, light placement parameters, ambiance parameters, climate zone parameters, pollution tolerance parameters, biodiversity support parameters, erosion control parameters, microclimate parameters, pathway parameters, seating parameters, outdoor structure parameters, privacy screen parameters, maintenance parameters, and the like. According to some embodiments, the configuration parameters available for a given adaptive area 206 can be dynamically generated based on characteristics of the adaptive area 206. It is noted that the foregoing examples are not meant to be limiting, and that the configuration parameters 208 can include any amount, type, form, etc., of information, at any level of granularity, consistent with the scope of this disclosure.

According to some embodiments, the software application 103 can collect the configuration parameters 208 and provide the configuration parameters 208 to the server device 106 for processing. In turn, the server device 106 can generate design outputs 212 for the adaptable areas 206 (e.g., using one or more of the generative AI models 110). The software application 103 can then receive, from the server device 106, the design outputs 212 generated by the generative AI models 110—which can include design features—and generate an updated architectural site design 220 with updated content 222. It should be appreciated that, in alternative embodiments, the server device 106 can generate and provide the updated architectural site design 220 to the software application 103.

According to some embodiments, the software application 103 can be configured to display the design features through different user interfaces. For example, the software application 103 can generate visual renderings that provide a realistic representation of how the architectural site will look after construction is carried out. The software application 103 can also generate simulations that provide users with realistic predictions, projections, etc., of how the architectural site will look (e.g., vegetation growth across grounds, building surfaces (e.g., rooftops, terraces, etc.), and the like)—as well as how the associated carbon metrics will evolve (e.g., increasing carbon sequestration as vegetation growth progresses)—as time passes. These visual outputs can help bridge technical and aesthetic aspects, thereby allowing users to evaluate the architectural site design 104 from both a practical and visual perspective. The software application 103 can also render carbon metrics calculated and provided by the server device 106. By presenting such information in an accessible and interactive manner, the software application 103 can facilitate user engagement and informed decision-making.

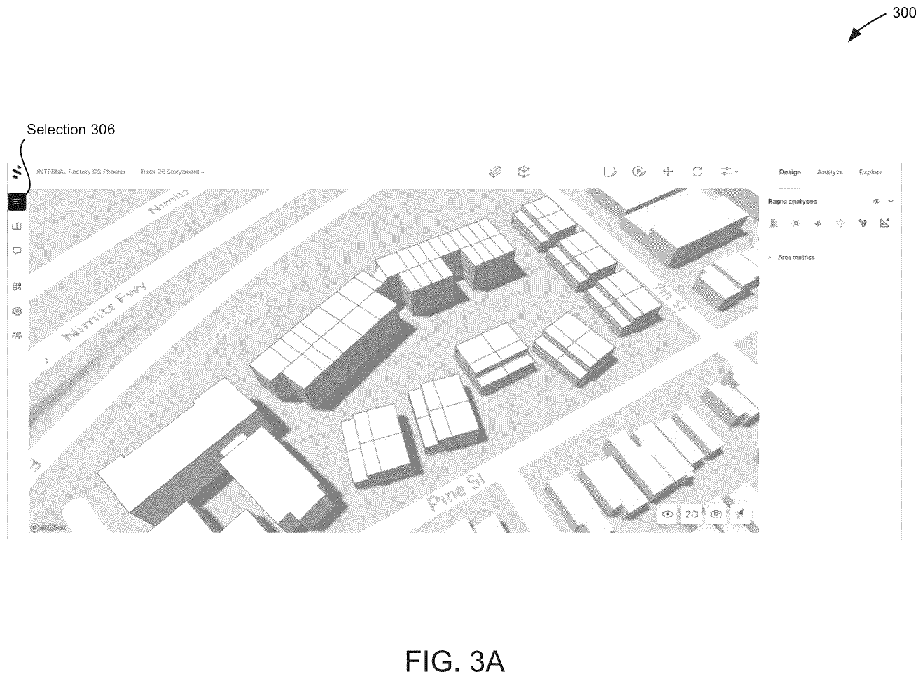

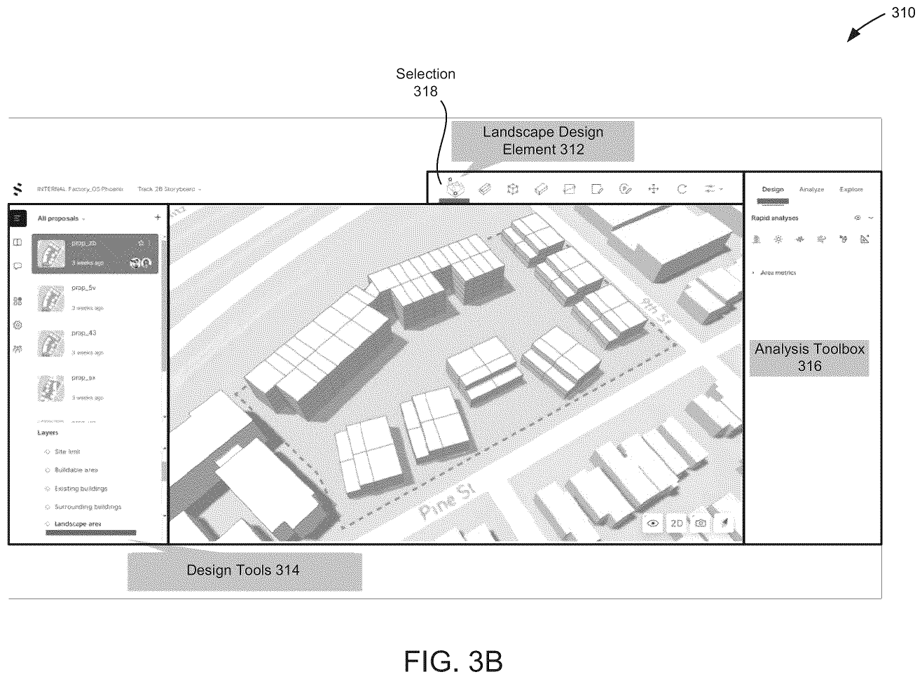

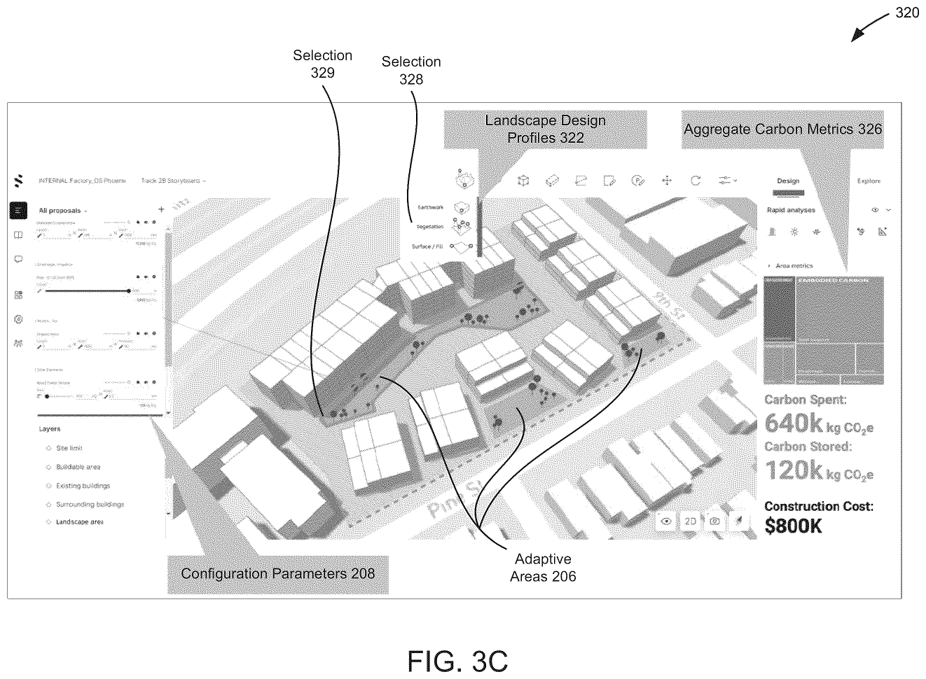

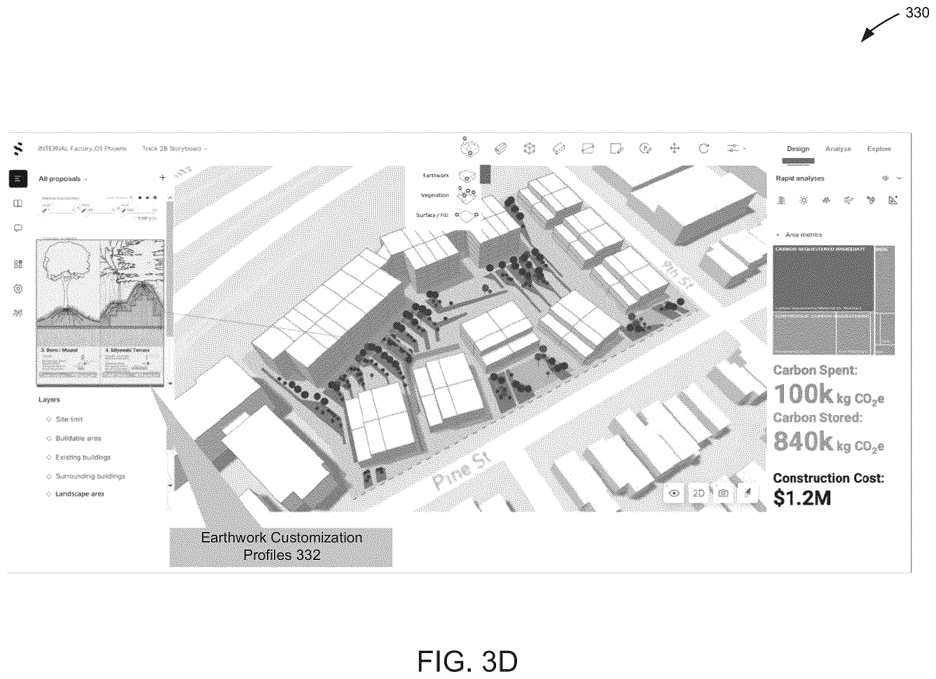

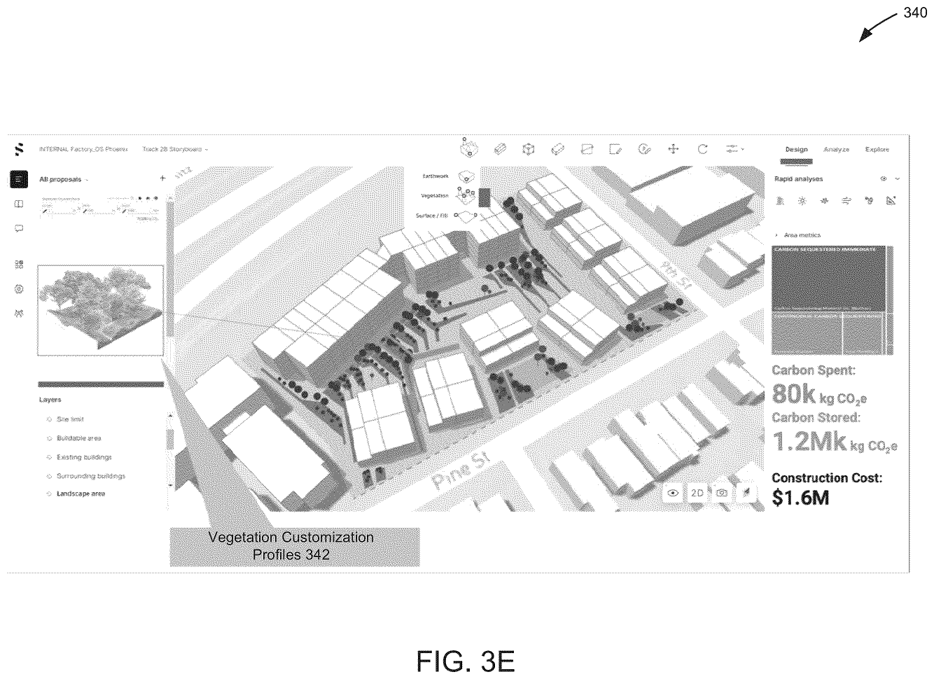

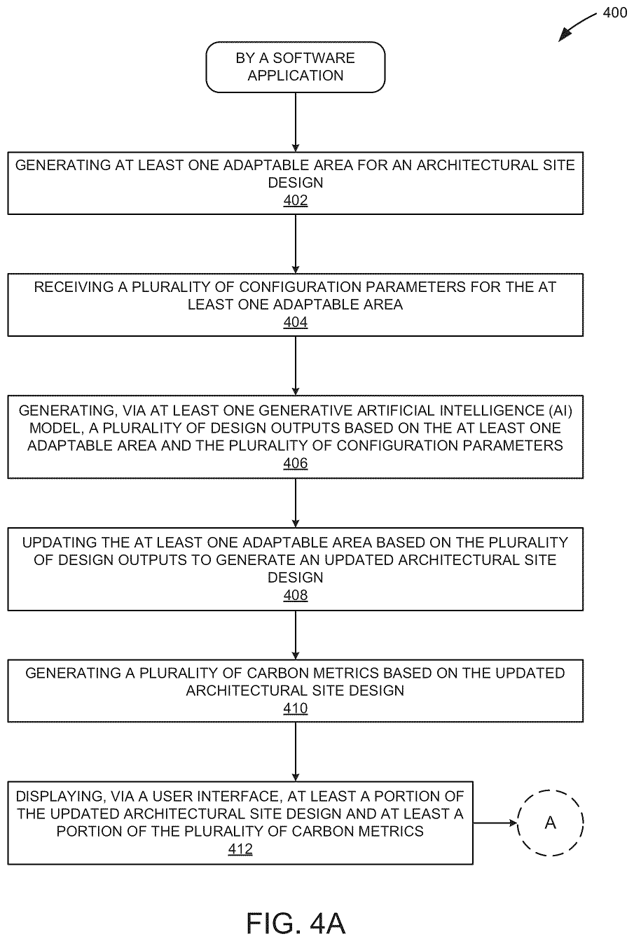

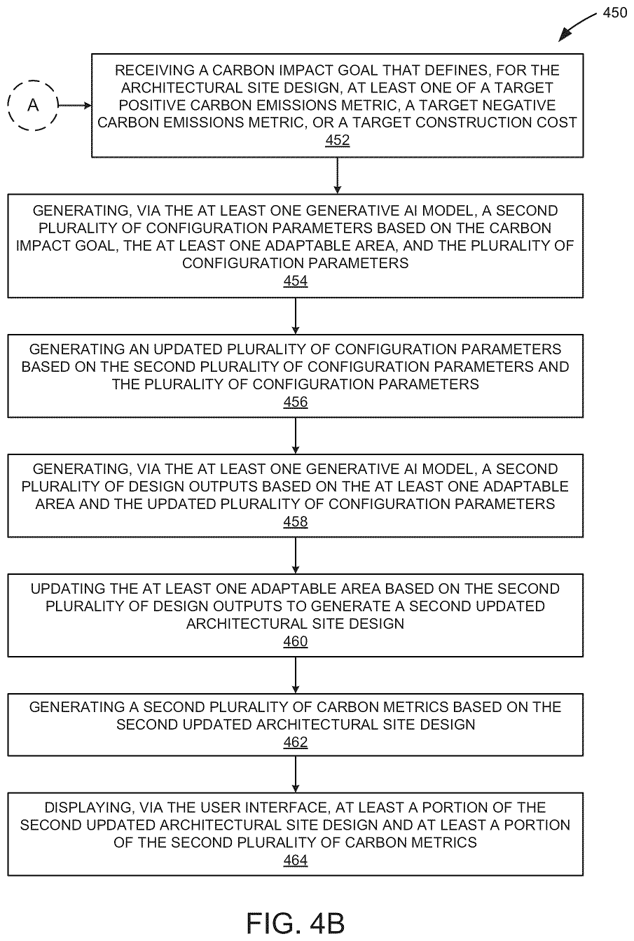

Additionally, the user interfaces provided by the software application 103 can enable users to specify carbon goals for the architectural site design 104, such as carbon spent constructing the architectural site, carbon stored by the architectural site, construction costs, and so on. In turn, the carbon goals can be provided to the server device 106 for analysis. In particular, the server device 106 can be configured to generate different sets of suggested configuration parameters 208 that, when applied to the adaptable areas 206 using the techniques described herein, generate different sets of outputs. According to some embodiments, each set of outputs, when applied against the adaptable areas 206 using the techniques described herein, can yield carbon metrics that potentially satisfy the carbon goals within a tolerable threshold. In this manner, the server device 106 can analyze the different sets of outputs to identify different sets of suggested configuration parameters 208 that are viable for achieving the carbon goals, and then provide one or more of the different sets of suggested configuration parameters 208 to the software application 103. In turn, the software application 103 can present the one or more different sets of suggested configuration parameters 208 via user interfaces, which can be selected, modified, etc., in accordance with user preferences. In this manner, users can browse through different designs that each satisfy the specified carbon goals within a tolerable threshold. A more detailed explanation of the functionality of the software application 103 is provided below in conjunction with FIGS. 3A-3E and 4A-4B.

According to some embodiments, the server device 106 can represent a computing device (e.g., a rack server, a blade server, a tower server, etc.). As shown in FIG. 1, the server device 106 can interface with one or more databases 108 that are implemented by the server device 106 (and/or other entities not illustrated in FIG. 1), which can be used to train generative AI models 110, store architectural site designs 104, and so on. As described herein, the server device 106 can be configured to receive different task requests from the software application 103. The task requests can include, for example, generating, based on configuration parameters 208, design outputs 212 for adaptable areas 206 within an architectural site design 104, generating carbon estimates for the architectural site design 104, generating suggested configuration parameters 208 based on specified carbon goals, and other tasks. In response, the server device 106 can perform different analyses, e.g., using the databases 108, one or more generative AI models 110, etc., to generate responses to the task requests. The server device 106 can provide the responses back to the software application 103, which can then be displayed to the user by way of different user interfaces. A more detailed explanation of the functionality of the server device 106 is provided below in conjunction with FIGS. 3A-3E and 4A-4B.

According to some embodiments, the generative AI models 110 can represent one or more trained machine learning models that are trained to generate the design outputs 212 described herein. For example, the AI models 110 can be implemented as large language models, computer vision models, graph neural networks, or other advanced architectures optimized for interpreting inputs (e.g., content 204 of an architectural site design 104, adaptable areas 206 within the architectural site design 104, configuration parameters 208 of the architectural site design 104, etc.) and generating the design outputs 212. According to some embodiments, the generative AI models 110 can be trained using extensive datasets of architectural site designs 104, environmental metrics, building and landscape components, and the like. It is noted that the foregoing examples are not meant to be limiting, and that the generative AI models 110 can be trained based on any amount, type, form, etc., of information, at any level of granularity, consistent with the scope of this disclosure.

According to some embodiments, the design outputs 212 generated by the generative AI models 110 can function as a comprehensive set of data that transforms the adaptable areas 206 into fully realized areas that take into account both aesthetic, functional, etc., requirements for the architectural site design 104. For example, the design outputs 212 can include information that defines the placement and distribution of elements like trees, plants, soils, berms, etc., within the adaptable areas 206, where each element is positioned, organized, etc., to reflect the configuration parameters 208 and the constraints of the architectural site design 104. According to some embodiments, the generative AI models 110 can analyze factors such as sizes, shapes, and spatial relationships of objects (e.g., buildings, grounds, etc.) within the architectural site design 104, as well as the specific environmental conditions, to determine where and how each element should be placed. Along with the placement information, the design outputs 212 can specify the type and characteristics of each element, e.g., by providing detailed information on the species of trees and plants, types of soils, and specifications for berms, such as respective dimensions, materials, slopes, and so on. These details can be used to align the elements with environmental goals and specific needs of the architectural site design 104, such as climate compatibility, soil conditions, and the like. The design outputs 212 can also include dimensional and structural data, such as data that specifies sizes of trees and plants, soil depths, heights and shapes of berms, etc., so that the adaptable areas 206 are aesthetically pleasing and structurally sound.

Additionally, the generative AI models 110 can optimize the environmental impact of the architectural site design 104 by generating design outputs 212 that take sustainability into account. For example, the design outputs 212 can include recommendations for plant species that are effective at carbon sequestration in the real-world environment of the architectural site, the placement of elements in ways that reduce soil erosion or enhance water retention, and the like. The design outputs 212 also can include predictions for the growth and maintenance of the landscape, which can be used to establish long-term projections of how the architectural site will evolve over time. For example, the design outputs 212 can include tree canopy coverage, the need for ongoing maintenance such as irrigation and pruning, and the like. Additionally, the generative AI models 110 can generate design outputs 212 that provide recommendations for water-efficient landscaping solutions, e.g., the use of drought-tolerant plants or the strategic placement of berms to manage rainfall and reduce irrigation needs. It is noted that the foregoing examples are not meant to be limiting, and that the design outputs 212 can include any amount, type, form, etc., of information, at any level of granularity, consistent with the scope of this disclosure.

It will be appreciated that the endpoint devices 102, the server devices 106, the databases 108, and the generative AI models 110 described in conjunction with FIG. 1 are illustrative, and that variations and modifications are possible. The connection topologies, including the number of CPUs and memories, may be modified as desired, and, in certain embodiments, one or more components shown in FIG. 1 not be present, or may be combined into fewer components. For example, in some embodiments, the endpoint device 102 can be configured to implement the techniques described herein so that interaction with one or more server devices 106 is not required. Further, in certain embodiments, one or more components shown in FIG. 1 may be implemented as virtualized resources in one or more virtual computing environments and/or cloud computing environments.

### User Interfaces

FIGS. 3A-3E illustrate conceptual diagrams of user interfaces associated with a software application 103 executing on one of the endpoint devices 102 of FIG. 1, according to various embodiments. As shown in FIG. 3A, a user interface 300 displays an example architectural site design 104 that includes a number of building that surround the architectural site design 104, a number of buildings included in the architectural site design 104, and grounds between the buildings of the architectural site design 104. In the example illustrated in FIG. 3A, the user interface 300 includes different user interface elements that enable a user to interact with and analyze the architectural site design 104. For example, when the user makes a selection 306 of a user interface element for viewing available options, the software application 103 displays the user interface 310 illustrated in FIG. 3B.

As shown in FIG. 3B, the user interface 310 includes a landscape design element 312 for modifying different aspects of the landscapes within the architectural site design 104, such as earthwork profiles, vegetation profiles, surface/fill profiles, and the like. The user interface 310 also includes design tools 314 that enable the user to select different versions of the architectural site design 104, different layers within the selected version of the architectural site design 104, and so on. The user interface 310 also includes an analysis toolbox 316 that displays information about various metrics associated with the architectural site design 104, such as aggregate carbon metrics. In the example illustrated in FIG. 3B, the user makes a selection 318 of the landscape design element 312, which causes the software application 103 to display the user interface 320 illustrated in FIG. 3C.

As shown in FIG. 3C, the user interface 320 displays landscape design profiles 322, which include the earthwork profiles, vegetation profiles, surface/fill profiles described herein. In the example illustrated in FIG. 3C, the user makes a selection 328, which causes the software application 103 to display three different adaptive areas 206 that are identified, generated, etc., in accordance with the techniques described herein. Additionally, the software application 103 displays configuration parameters 208 that are identified and that correspond to one of the adaptive areas 206 that is selected by the user by way of a selection 329. As shown in FIG. 3C, the configuration parameters 208 enable the user to specify settings for different categories of configuration parameters 208, such as settings for crushed stone to be installed within the selected adaptive area 206, settings for drainage and irrigation installations to be installed within the selected adaptive area 206, settings for mulch and soil to be installed within the selected adaptive area 206, settings for site elements to be installed within the selected adaptive area 206, as well as other settings. As also shown in FIG. 3C, the user interface 320 can display respective estimated carbon metrics for the different categories of configuration parameters 208, so the user can conveniently determine how the different categories—as well as changes to the settings of the different categories—individually contribute to the aggregate carbon metrics associated with the architectural site design 104.

As shown in FIG. 3C, the design of the selected adaptive area 206 is updated based on the configuration parameters 208 specified by the user. Additionally, the user interface 320 displays aggregate carbon metrics 326, which reflect an estimated amount of carbon that will be spent (i.e., produced) constructing the architectural site, an estimated amount of carbon that will be saved by the architectural site, an estimated cost of constructing the architectural site, and so on. In this manner, the user can observe, in near-real-time, how changes made to the configuration parameters 208 affect the appearances of the adaptive areas 206, the values of the aggregate carbon metrics 326, and so on.

According to some embodiments, the aggregate carbon metrics 326 can be displayed via user interface elements (e.g., text boxes, sliders, etc.) that enable the values of the aggregate carbon metrics 326 to be adjusted in accordance with carbon goals. For example, and as described herein, at least one of the carbon spent metric, the carbon stored metric, or the construction cost metric can be adjusted by the user to cause the configuration parameters 208 to be adjusted. In turn, the adjustments to the configuration parameters 208 can cause the elements within one or more of the adaptive areas 206 to be adjusted based on the adjusted configuration parameters 208. In this manner, the user can beneficially and conveniently modify different aspects of the carbon metrics to review different architectural site design 104 options that are effective for meeting particular carbon goals.

Additionally, and as shown in the user interface 330 of FIG. 3D, the software application 103 can enable the user to select from among different earthwork customization profiles 332, which can include berms/mounds, terraces, and so on. As shown in FIG. 3D, the user interface 330 can include respective carbon metrics for each earthwork customization profile 332, as well as user interface elements for adjusting settings associated with the earthwork customization profiles 332. As shown in FIG. 3D, selections of different earthwork customization profiles 332 can cause additional adaptive areas 206 to be generated, as well as changes to the elements distributed within the adaptive areas 206 based on the selected earthwork customization profiles 332, associated settings, and so on. Additionally, the selections of the different earthwork customization profiles 332 can cause the aggregate carbon metrics 326 to be updated to reflect the changes. Additionally, and as shown in the user interface 340 of FIG. 3E, the software application 103 can enable the user to select from among different vegetation customization profiles 342, which can include collections of trees, paths, ground features, and so on. The selection of a vegetation customization profile 342 can cause the aggregate carbon metrics 326 to be updated to reflect the selection.

It is noted that the user interfaces illustrated in FIGS. 3A-3E are not meant to be limiting, and that the user interfaces can include any number, type, form, etc., of user interface element(s), configured to cause any number of operations to be performed, consistent with the scope of this disclosure.

### Architectural Site Design Generation Methods

FIG. 4A sets forth a flow diagram of method steps for generating architectural site designs based on carbon considerations, according to various embodiments. In the following description, a method 400 is described as being implemented by the software application 103, but it should be appreciated that the software application 103 can implement the method 400 with the assistance of other entities, such as the server device 106. As shown, the method 400 begins at step 402, where the software application 103 generates at least one adaptable area for an architectural site design (e.g., as described above in conjunction with FIGS. 1-2 and 3A-3E).

At step 404, the software application 103 receives a plurality of configuration parameters for the at least one adaptable area (e.g., as described above in conjunction with FIGS. 1-2 and 3A-3E). At step 406, the software application 103 generates, via at least one generative artificial intelligence (AI) model, a plurality of design outputs based on the at least one adaptable area and the plurality of configuration parameters (e.g., as described above in conjunction with FIGS. 1-2 and 3A-3E).

At step 408, the software application 103 updates the at least one adaptable area based on the plurality of design outputs to generate an updated architectural site design (e.g., as described above in conjunction with FIGS. 1-2 and 3A-3E). At step 410, the software application 103 generates a plurality of carbon metrics based on the updated architectural site design (e.g., as described above in conjunction with FIGS. 1-2 and 3A-3E). At step 412, the software application 103 displays, via a user interface, at least a portion of the updated architectural site design and at least a portion of the plurality of carbon metrics (e.g., as described above in conjunction with FIGS. 1-2 and 3A-3E).

FIG. 4B sets forth a flow diagram of method steps for generating architectural site designs based on carbon goals, according to various embodiments. In the following description, a method 450 is described as being implemented by the software application 103, but it should be appreciated that the software application 103 can implement the method 450 with the assistance of other entities, such as the server device 106. As shown, the method 450 begins at step 452, where the software application 103 receives a carbon goal that defines, for the architectural site design, at least one of a target positive carbon emissions metric, a target negative carbon emissions metric, or a target construction cost (e.g., as described above in conjunction with FIGS. 1-2 and 3A-3E).

At step 454, the software application 103 generates, via the at least one generative ai model, a second plurality of configuration parameters based on the carbon goal, the at least one adaptable area, and the plurality of configuration parameters (e.g., as described above in conjunction with FIGS. 1-2 and 3A-3E). At step 456, the software application 103 generates an updated plurality of configuration parameters based on the second plurality of configuration parameters and the plurality of configuration parameters (e.g., as described above in conjunction with FIGS. 1-2 and 3A-3E). At step 458, the software application 103 generates, via the at least one generative ai model, a second plurality of design outputs based on the at least one adaptable area and the updated plurality of configuration parameters (e.g., as described above in conjunction with FIGS. 1-2 and 3A-3E).

At step 460, the software application 103 updates the at least one adaptable area based on the second plurality of design outputs to generate a second updated architectural site design (e.g., as described above in conjunction with FIGS. 1-2 and 3A-3E). At step 462, the software application 103 generates a second plurality of carbon metrics based on the second updated architectural site design (e.g., as described above in conjunction with FIGS. 1-2 and 3A-3E). At step 464, the software application 103 displays, via the user interface, at least a portion of the second updated architectural site design and at least a portion of the second plurality of carbon metrics (e.g., as described above in conjunction with FIGS. 1-2 and 3A-3E).

### Computing Device Overview

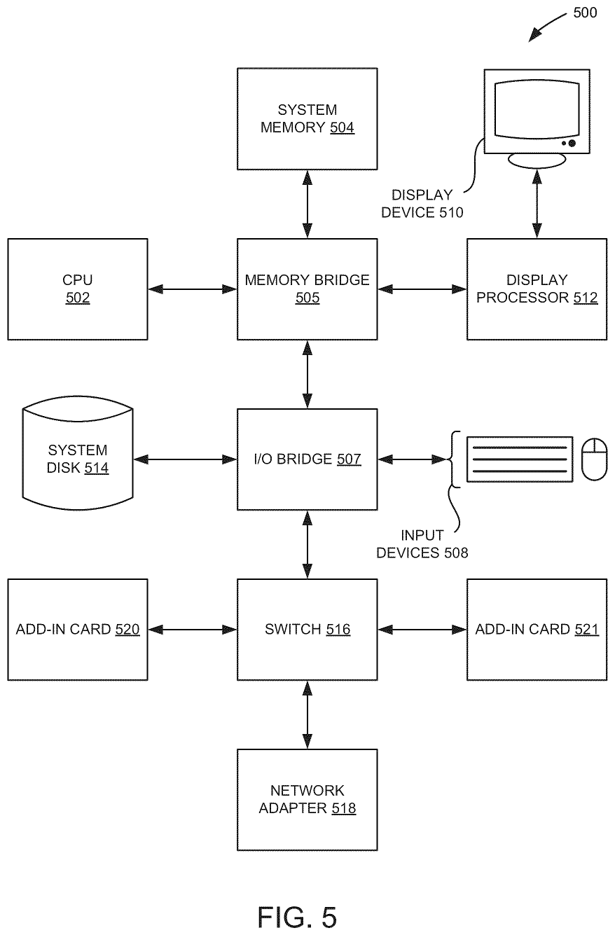

FIG. 5 is a more detailed illustration of a computing device that can implement the functionalities of the entities illustrated in FIG. 1, according to various embodiments. This figure in no way limits or is intended to limit the scope of the various embodiments. In various implementations, system 500 may be an augmented reality, virtual reality, or mixed reality system or device, a personal computer, video game console, personal digital assistant, mobile phone, mobile device or any other device suitable for practicing the various embodiments. Further, in various embodiments, any combination of two or more systems 500 may be coupled together to practice one or more aspects of the various embodiments.

As shown, system 500 includes a central processing unit (CPU) 502 and a system memory 504 communicating via a bus path that may include a memory bridge 505. CPU 502 includes one or more processing cores, and, in operation, CPU 502 is the master processor of system 500, controlling and coordinating operations of other system components. System memory 504 stores software applications and data for use by CPU 502. CPU 502 runs software applications and optionally an operating system. Memory bridge 505, which may be, e.g., a Northbridge chip, is connected via a bus or other communication path (e.g., a HyperTransport link) to an I/O (input/output) bridge 507. I/O bridge 507, which may be, e.g., a Southbridge chip, receives user input from one or more user input devices 508 (e.g., keyboard, mouse, joystick, digitizer tablets, touch pads, touch screens, still or video cameras, motion sensors, and/or microphones) and forwards the input to CPU 502 via memory bridge 505.

A display processor 512 is coupled to memory bridge 505 via a bus or other communication path (e.g., a PCI Express, Accelerated Graphics Port, or HyperTransport link); in one embodiment display processor 512 is a graphics subsystem that includes at least one graphics processing unit (GPU) and graphics memory. Graphics memory includes a display memory (e.g., a frame buffer) used for storing pixel data for each pixel of an output image. Graphics memory can be integrated in the same device as the GPU, connected as a separate device with the GPU, and/or implemented within system memory 504.

Display processor 512 periodically delivers pixels to a display device 510 (e.g., a screen or conventional CRT, plasma, OLED, SED or LCD based monitor or television). Additionally, display processor 512 may output pixels to film recorders adapted to reproduce computer generated images on photographic film. Display processor 512 can provide display device 510 with an analog or digital signal. In various embodiments, one or more of the various graphical user interfaces set forth in FIG. 3 are displayed to one or more users via display device 510, and the one or more users can input data into and receive visual output from those various graphical user interfaces.

A system disk 514 is also connected to I/O bridge 507 and may be configured to store content and applications and data for use by CPU 502 and display processor 512. System disk 514 provides non-volatile storage for applications and data and may include fixed or removable hard disk drives, flash memory devices, and CD-ROM, DVD-ROM, Blu-ray, HD-DVD, or other magnetic, optical, or solid state storage devices.

A switch 516 provides connections between I/O bridge 507 and other components such as a network adapter 518 and various add-in cards 520 and 521. Network adapter 518 allows system 500 to communicate with other systems via an electronic communications network, and may include wired or wireless communication over local area networks and wide area networks such as the Internet.

Other components (not shown), including USB or other port connections, film recording devices, and the like, may also be connected to I/O bridge 507. For example, an audio processor may be used to generate analog or digital audio output from instructions and/or data provided by CPU 502, system memory 504, or system disk 514. Communication paths interconnecting the various components in FIG. 5 may be implemented using any suitable protocols, such as PCI (Peripheral Component Interconnect), PCI Express (PCI-E), AGP (Accelerated Graphics Port), HyperTransport, or any other bus or point-to-point communication protocol(s), and connections between different devices may use different protocols, as is known in the art.

In one embodiment, display processor 512 incorporates circuitry optimized for graphics and video processing, including, for example, video output circuitry, and constitutes a graphics processing unit (GPU). In another embodiment, display processor 512 incorporates circuitry optimized for general purpose processing. In yet another embodiment, display processor 512 may be integrated with one or more other system elements, such as the memory bridge 505, CPU 502, and I/O bridge 507 to form a system on chip (SoC). In still further embodiments, display processor 512 is omitted and software executed by CPU 502 performs the functions of display processor 512.

Pixel data can be provided to display processor 512 directly from CPU 502. In some embodiments, instructions and/or data representing a scene are provided to a render farm or a set of server computers, each similar to system 500, via network adapter 518 or system disk 514. The render farm generates one or more rendered images of the scene using the provided instructions and/or data. These rendered images may be stored on computer-readable media in a digital format and optionally returned to system 500 for display. Similarly, stereo image pairs processed by display processor 512 may be output to other systems for display, stored in system disk 514, or stored on computer-readable media in a digital format.

Alternatively, CPU 502 provides display processor 512 with data and/or instructions defining the desired output images, from which display processor 512 generates the pixel data of one or more output images, including characterizing and/or adjusting the offset between stereo image pairs. The data and/or instructions defining the desired output images can be stored in system memory 504 or graphics memory within display processor 512. In an embodiment, display processor 512 includes 3D rendering capabilities for generating pixel data for output images from instructions and data defining the geometry, lighting shading, texturing, motion, and/or camera parameters for a scene. Display processor 512 can further include one or more programmable execution units capable of executing shader programs, tone mapping programs, and the like.

Further, in other embodiments, CPU 502 or display processor 512 may be replaced with or supplemented by any technically feasible form of processing device configured process data and execute program code. Such a processing device could be, for example, a central processing unit (CPU), a graphics processing unit (GPU), an application-specific integrated circuit (ASIC), a field-programmable gate array (FPGA), and so forth. In various embodiments any of the operations and/or functions described herein can be performed by CPU 502, display processor 512, or one or more other processing devices or any combination of these different processors.

CPU 502, render farm, and/or display processor 512 can employ any surface or volume rendering technique known in the art to create one or more rendered images from the provided data and instructions, including rasterization, scanline rendering REYES or micropolygon rendering, ray casting, ray tracing, image-based rendering techniques, and/or combinations of these and any other rendering or image processing techniques known in the art.

In other contemplated embodiments, system 500 may be a robot or robotic device and may include CPU 502 and/or other processing units or devices and system memory 504. In such embodiments, system 500 may or may not include other elements shown in FIG. 5. System memory 504 and/or other memory units or devices in system 500 may include instructions that, when executed, cause the robot or robotic device represented by system 500 to perform one or more operations, steps, tasks, or the like.

It will be appreciated that the system shown herein is illustrative and that variations and modifications are possible. The connection topology, including the number and arrangement of bridges, may be modified as desired. For instance, in some embodiments, system memory 504 is connected to CPU 502 directly rather than through a bridge, and other devices communicate with system memory 504 via memory bridge 505 and CPU 502. In other alternative topologies display processor 512 is connected to I/O bridge 507 or directly to CPU 502, rather than to memory bridge 505. In still other embodiments, I/O bridge 507 and memory bridge 505 might be integrated into a single chip. The particular components shown herein are optional; for instance, any number of add-in cards or peripheral devices might be supported. In some embodiments, switch 516 is eliminated, and network adapter 518 and add-in cards 520, 521 connect directly to I/O bridge 507.

In sum, the disclosed embodiments set forth techniques for generating architectural site designs based on carbon considerations and goals. In particular, the disclosed techniques set forth a dynamic process for identifying adaptable areas within an architectural site design based on input data and predefined constraints provided by a software application. The adaptable areas serve as the foundation for the architectural site design, which can be customized further through a set of configuration parameters specified by the user. Upon receipt of the configuration parameters, the server device can utilize generative AI models to analyze the adaptable areas and the configuration parameters to generate a variety of design outputs that help guide the architectural site design process. In particular, the design outputs can be used to refine the adaptable areas to generate an updated architectural site design. Along with the design updates, the server device can calculate carbon metrics, including emissions and savings, which are directly tied to the changes made in the design. The final step involves presenting both the updated design and the carbon metrics to the user via an interface, allowing for review and further adjustments. This integrated approach combines automated design generation, real-time user input, advanced AI processing, and environmental analysis to create an efficient and comprehensive site development workflow.

One technical advantage of the disclosed techniques relative to the prior art is that the disclosed techniques automate the detection of areas within an architectural site development where elements such as trees, plants, structures, etc., can be installed. This automation can reduce the need for manual identification of such areas, which can help reduce errors and ensure that the areas are identified consistently based on predefined criteria and constraints. Another technical advantage is that the disclosed techniques allow for dynamic adjustments to design parameters through configurable properties. The adjustments can be processed in real-time such that modifications to the design criteria can be reflected with virtually no latency, which can improve the overall precision and relevance of the suggested architectural site designs. A further technical advantage is that the disclosed techniques can programmatically calculate carbon emissions and savings, thereby eliminating the need for manual computations. These calculations can be directly tied to the detected areas and configured parameters, which can help reduce the potential for computational errors. An additional technical advantage is that the disclosed techniques can automatically generate values for the configurable properties based on specified carbon goals.
1. In some embodiments, a method for generating architectural site designs based on carbon considerations comprises generating at least one adaptable area for an architectural site design; receiving a plurality of configuration parameters for the at least one adaptable area; generating, via at least one generative artificial intelligence (AI) model, a plurality of design outputs based on the at least one adaptable area and the plurality of configuration parameters; updating the at least one adaptable area based on the plurality of design outputs to generate an updated architectural site design; generating a plurality of carbon metrics based on the updated architectural site design; and displaying, via a user interface, at least a portion of the updated architectural site design and at least a portion of the plurality of carbon metrics.
2. The computer-implemented method of clause 1, wherein updating the at least one adaptable area based on the plurality of design outputs to generate the updated architectural site design comprises adding, to the at least one adaptable area, at least one feature that corresponds to at least one configuration parameter included in the plurality of configuration parameters.
3. The computer-implemented method of clause 1, wherein the plurality of carbon metrics includes at least one of positive carbon emissions from construction activities associated with the updated architectural site design or negative carbon emissions from carbon sequestration designs associated with the updated architectural site design.
4. The computer-implemented method of clause 3, wherein displaying the at least a portion of the plurality of carbon metrics comprises displaying at least one graph that illustrates a distribution of the positive carbon emissions relative to the negative carbon emissions.
5. The computer-implemented method of clause 1, wherein the architectural site design is included in a computer-aided design (CAD) file that defines at least one structure and at least one boundary that encloses the architectural site design.
6. The computer-implemented method of clause 5, wherein the at least one adaptable area is associated with at least one of at least a portion of the at least one structure or at least a portion of the at least one adaptable area.
7. The computer-implemented method of clause 1, further comprising generating a construction cost estimate for the updated architectural site design; and displaying at least a portion of the construction cost estimate via the user interface.
8. The computer-implemented method of clause 1, wherein at least one configuration parameter included in the plurality of configuration parameters is received via at least one user interface element include in a plurality of user interface elements displayed in the user interface.
9. The computer-implemented method of clause 1, further comprising receiving a carbon goal that defines, for the architectural site design, at least one of a target positive carbon emissions metric, a target negative carbon emissions metric, or a target construction cost; generating, via the at least one generative AI model, a second plurality of configuration parameters based on the carbon goal, the at least one adaptable area, and the plurality of configuration parameters; and generating an updated plurality of configuration parameters based on the second plurality of configuration parameters and the plurality of configuration parameters.
10. The computer-implemented method of clause 9, further comprising generating, via the at least one generative AI model, a second plurality of design outputs based on the at least one adaptable area and the updated plurality of configuration parameters; updating the at least one adaptable area based on the second plurality of design outputs to generate a second updated architectural site design; generating a second plurality of carbon metrics based on the second updated architectural site design; and displaying, via the user interface, at least a portion of the second updated architectural site design and at least a portion of the second plurality of carbon metrics.
11. In some embodiments, one or more non-transitory computer readable media store instructions that, when executed by one or more processors, cause the one or more processors to generate architectural site designs based on carbon considerations, by performing the operations of generating at least one adaptable area for an architectural site design; receiving a plurality of configuration parameters for the at least one adaptable area; generating, via at least one generative artificial intelligence (AI) model, a plurality of design outputs based on the at least one adaptable area and the plurality of configuration parameters; updating the at least one adaptable area based on the plurality of design outputs to generate an updated architectural site design; generating a plurality of carbon metrics based on the updated architectural site design; and displaying, via a user interface, at least a portion of the updated architectural site design and at least a portion of the plurality of carbon metrics.
12. The one or more non-transitory computer readable media of clause 11, wherein the plurality of configuration parameters includes at least one of zoning parameters, functional area parameters, soil type parameters, ground surface parameters, accessibility parameters, sunlight exposure parameters, wind pattern parameters, tree type parameters, vegetation type parameters, planting density parameters, planting arrangement parameters, irrigation parameters, watering schedule parameters, water feature parameters, drainage parameters, berm parameters, mound parameters, slope parameters, light placement parameters, ambiance parameters, climate zone parameters, pollution tolerance parameters, biodiversity support parameters, erosion control parameters, microclimate parameters, pathway parameters, seating parameters, outdoor structure parameters, privacy screen parameters, or maintenance parameters.
13. The one or more non-transitory computer readable media of clause 11, wherein the user interface includes at least one user interface element for adjusting at least one configuration parameter included in the plurality of configuration parameters.
14. The one or more non-transitory computer readable media of clause 11, wherein the at least one adaptable area comprises at least one of a ground area included in the architectural site design that is uncovered by a structure, or at least one of a rooftop or a terrace of a structure included in the architectural site design.
15. The one or more non-transitory computer readable media of clause 11, wherein updating the at least one adaptable area based on the plurality of design outputs to generate the updated architectural site design comprises adding, to the at least one adaptable area, at least one feature that corresponds to at least one configuration parameter included in the plurality of configuration parameters.
16. The one or more non-transitory computer readable media of clause 11, wherein the plurality of carbon metrics includes at least one of positive carbon emissions from construction activities associated with the updated architectural site design or negative carbon emissions from carbon sequestration designs associated with the updated architectural site design.
17. The one or more non-transitory computer readable media of clause 16, wherein displaying the at least a portion of the plurality of carbon metrics comprises displaying at least one graph that illustrates a distribution of the positive carbon emissions relative to the negative carbon emissions.
18. The one or more non-transitory computer readable media of clause 11, wherein the architectural site design is included in a computer-aided design (CAD) file that defines at least one structure and at least one boundary that encloses the architectural site design.
19. The one or more non-transitory computer readable media of clause 18, wherein the at least one adaptable area is associated with at least one of at least a portion of the at least one structure or at least a portion of the at least one adaptable area.
20. In some embodiments, a computer system comprises one or more memories that include instructions, and one or more processors that are coupled to the one or more memories, and that, when executing the instructions, are configured to generate architectural site designs based on carbon considerations, by performing the operations of generating at least one adaptable area for an architectural site design; receiving a plurality of configuration parameters for the at least one adaptable area; generating, via at least one generative artificial intelligence (AI) model, a plurality of design outputs based on the at least one adaptable area and the plurality of configuration parameters; updating the at least one adaptable area based on the plurality of design outputs to generate an updated architectural site design; generating a plurality of carbon metrics based on the updated architectural site design; and displaying, via a user interface, at least a portion of the updated architectural site design and at least a portion of the plurality of carbon metrics.

Any and all combinations of any of the claim elements recited in any of the claims and/or any elements described in this application, in any fashion, fall within the contemplated scope of the present disclosure and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The invention has been described above with reference to specific embodiments. Persons of ordinary skill in the art, however, will understand that various modifications and changes may be made thereto without departing from the broader spirit and scope of the invention as set forth in the appended claims. For example, and without limitation, although many of the descriptions herein refer to specific types of I/O devices that may acquire data associated with an object of interest, persons skilled in the art will appreciate that the systems and techniques described herein are applicable to other types of I/O devices. The foregoing description and drawings are, accordingly, to be regarded in an illustrative rather than a restrictive sense.

While the preceding is directed to embodiments of the present disclosure, other and further embodiments of the disclosure may be devised without departing from the basic scope thereof, and the scope thereof is determined by the claims that follow.

What is claimed is:

1. A method for generating architectural site designs based on carbon considerations, the method comprising:
generating at least one adaptable area for an architectural site design;
receiving a plurality of configuration parameters for the at least one adaptable area;
generating, via at least one generative artificial intelligence (AI) model, a plurality of design outputs based on the at least one adaptable area and the plurality of configuration parameters;
updating the at least one adaptable area based on the plurality of design outputs to generate an updated architectural site design;
generating a plurality of carbon metrics based on the updated architectural site design; and
displaying, via a user interface, at least a portion of the updated architectural site design and at least a portion of the plurality of carbon metrics.

2. The computer-implemented method of claim 1, wherein updating the at least one adaptable area based on the plurality of design outputs to generate the updated architectural site design comprises adding, to the at least one adaptable area, at least one feature that corresponds to at least one configuration parameter included in the plurality of configuration parameters.

3. The computer-implemented method of claim 1, wherein the plurality of carbon metrics includes at least one of positive carbon emissions from construction activities associated with the updated architectural site design or negative carbon emissions from carbon sequestration designs associated with the updated architectural site design.

4. The computer-implemented method of claim 3, wherein displaying the at least a portion of the plurality of carbon metrics comprises displaying at least one graph that illustrates a distribution of the positive carbon emissions relative to the negative carbon emissions.

5. The computer-implemented method of claim 1, wherein the architectural site design is included in a computer-aided design (CAD) file that defines at least one structure and at least one boundary that encloses the architectural site design.

6. The computer-implemented method of claim 5, wherein the at least one adaptable area is associated with at least one of at least a portion of the at least one structure or at least a portion of the at least one adaptable area.

7. The computer-implemented method of claim 1, further comprising:
generating a construction cost estimate for the updated architectural site design; and
displaying at least a portion of the construction cost estimate via the user interface.

8. The computer-implemented method of claim 1, wherein at least one configuration parameter included in the plurality of configuration parameters is received via at least one user interface element include in a plurality of user interface elements displayed in the user interface.

9. The computer-implemented method of claim 1, further comprising:
receiving a carbon goal that defines, for the architectural site design, at least one of a target positive carbon emissions metric, a target negative carbon emissions metric, or a target construction cost;
generating, via the at least one generative AI model, a second plurality of configuration parameters based on the carbon goal, the at least one adaptable area, and the plurality of configuration parameters; and
generating an updated plurality of configuration parameters based on the second plurality of configuration parameters and the plurality of configuration parameters.

10. The computer-implemented method of claim 9, further comprising:
generating, via the at least one generative AI model, a second plurality of design outputs based on the at least one adaptable area and the updated plurality of configuration parameters;
updating the at least one adaptable area based on the second plurality of design outputs to generate a second updated architectural site design;
generating a second plurality of carbon metrics based on the second updated architectural site design; and
displaying, via the user interface, at least a portion of the second updated architectural site design and at least a portion of the second plurality of carbon metrics.

11. One or more non-transitory computer readable media storing instructions that, when executed by one or more processors, cause the one or more processors to generate architectural site designs based on carbon considerations, by performing the operations of:
generating at least one adaptable area for an architectural site design;
receiving a plurality of configuration parameters for the at least one adaptable area;
generating, via at least one generative artificial intelligence (AI) model, a plurality of design outputs based on the at least one adaptable area and the plurality of configuration parameters;
updating the at least one adaptable area based on the plurality of design outputs to generate an updated architectural site design;
generating a plurality of carbon metrics based on the updated architectural site design; and
displaying, via a user interface, at least a portion of the updated architectural site design and at least a portion of the plurality of carbon metrics.

12. The one or more non-transitory computer readable media of claim 11, wherein the plurality of configuration parameters includes at least one of zoning parameters, functional area parameters, soil type parameters, ground surface parameters, accessibility parameters, sunlight exposure parameters, wind pattern parameters, tree type parameters, vegetation type parameters, planting density parameters, planting arrangement parameters, irrigation parameters, watering schedule parameters, water feature parameters, drainage parameters, berm parameters, mound parameters, slope parameters, light placement parameters, ambiance parameters, climate zone parameters, pollution tolerance parameters, biodiversity support parameters, erosion control parameters, microclimate parameters, pathway parameters, seating parameters, outdoor structure parameters, privacy screen parameters, or maintenance parameters.

13. The one or more non-transitory computer readable media of claim 11, wherein the user interface includes at least one user interface element for adjusting at least one configuration parameter included in the plurality of configuration parameters.

14. The one or more non-transitory computer readable media of claim 11, wherein the at least one adaptable area comprises at least one of a ground area included in the architectural site design that is uncovered by a structure, or at least one of a rooftop or a terrace of a structure included in the architectural site design.

15. The one or more non-transitory computer readable media of claim 11, wherein updating the at least one adaptable area based on the plurality of design outputs to generate the updated architectural site design comprises adding, to the at least one adaptable area, at least one feature that corresponds to at least one configuration parameter included in the plurality of configuration parameters.

16. The one or more non-transitory computer readable media of claim 11, wherein the plurality of carbon metrics includes at least one of positive carbon emissions from construction activities associated with the updated architectural site design or negative carbon emissions from carbon sequestration designs associated with the updated architectural site design.

17. The one or more non-transitory computer readable media of claim 16, wherein displaying the at least a portion of the plurality of carbon metrics comprises displaying at least one graph that illustrates a distribution of the positive carbon emissions relative to the negative carbon emissions.

18. The one or more non-transitory computer readable media of claim 11, wherein the architectural site design is included in a computer-aided design (CAD) file that defines at least one structure and at least one boundary that encloses the architectural site design.

19. The one or more non-transitory computer readable media of claim 18, wherein the at least one adaptable area is associated with at least one of at least a portion of the at least one structure or at least a portion of the at least one adaptable area.

20. A computer system, comprising:
one or more memories that include instructions; and
one or more processors that are coupled to the one or more memories and, when executing the instructions, are configured to generate architectural site designs based on carbon considerations, by performing the operations of:
generating at least one adaptable area for an architectural site design;
receiving a plurality of configuration parameters for the at least one adaptable area;
generating, via at least one generative artificial intelligence (AI) model, a plurality of design outputs based on the at least one adaptable area and the plurality of configuration parameters;
updating the at least one adaptable area based on the plurality of design outputs to generate an updated architectural site design;
generating a plurality of carbon metrics based on the updated architectural site design; and
displaying, via a user interface, at least a portion of the updated architectural site design and at least a portion of the plurality of carbon metrics.
